(19) United States
(12) Patent Application Publication
(10) Pub. No.: US 2013/0199725 A1
(43) Pub. Date: Aug. 8, 2013

(54) STORAGE-STABLE, NCO-FREE LAMINATING ADHESIVE

(71) Applicant: Henkel AG & Co. KGaA, Duesseldorf (DE)

(72) Inventors: Pavel Gentschev, Bad Golsern (AU); Christoph Lohr, Mettmann (DE); Christoph Loschen, Erkrath (DE)

(73) Assignee: Henkel AG & Co. KGaA, Duesseldorf (DE)

(21) Appl. No.: 13/804,959

(22) Filed: Mar. 14, 2013

Related U.S. Application Data
(63) Continuation of application No. PCT/EP2011/072853, filed on Dec. 15, 2011.

(51) Int. Cl. C09J 175/06

(52) U.S. Cl. CPC C09J 175/06
USPC 156/334; 524/505

(57) ABSTRACT

The invention relates to a crosslinkable one-component laminating adhesive containing (i) 25 to 80 wt % polyester prepolymers, polyether prepolymers, and/or polyurethane prepolymers that are free of NCO groups and comprise at least one crosslinkable alkoxysilane group, as well as additionally NCO groups reacted with compounds that contain no hydrolyzable groups, and the prepolymer possesses a molecular weight from 2000 to 30,000 g/mol, (ii) 75 to 20 wt % organic solvent having a boiling point of up to 130° C., (iii) 1 to 20 wt % polymers, oligomers, and/or monomers that contain one or more anhydride groups, (iv) 0 to 15 wt % additives, where the viscosity of the adhesive is between 50 and 20,000 mPas (per DIN ISO 2555), measured at 15 to 45° C.

The invention relates to an adhesive based on polyurethane prepolymers containing hydrolyzable silane groups, for adhesive bonding of planar substrates. The invention further relates to the use of this adhesive as a laminating adhesive for multi-layer films or foils.

Transparent NCO-crosslinking one-component adhesives as a reaction product of polyols and isocyanates are known from EP 0 464 483, in which isocyanates that comprise urea groups are used. Such urea groups exhibit a high level of hydrogen bridge bonding, and the polymers are thus usually highly viscous. In addition, monomeric isocyanates in the context of polymer manufacture result in a residual monomer content of health-damaging isocyanates, which must be decreased by additional actions.

U.S. Pat. No. 5,990,257 is also known. This describes a method for manufacturing polyurethanes comprising silyl groups, isocyanates being used at a deficit with respect to polyols. Further OH groups are then reacted with isocyanatosilanes to yield silyl-group-containing prepolymers. The polymers have a molecular weight of more than 12,000 g/mol. The viscosity is above 57 Pa·s. An application described is use as a sealing substance that is said to have low adhesion after curing.

DE 10 2009 026 900 describes laminating adhesives that contain alcohols as solvents. Prepolymers based on polyurethanes that contain crosslinkable silane groups are described for this. These adhesives have, however, a high concentration of alcohols, for example methanol or ethanol. Actions to decrease the alcohols are not described.

EP 1 674 546 is also known. This describes moisture-curing compositions that are obtained from NCO-group-containing polyurethanes that are reacted with nucleophilically substituted silanes. The fast reaction of these adhesives with moisture is described. The adhesives are used as melt adhesives, i.e. they exist as a solid at room temperature and can only be applied when hot.

DE 10 2010 000 881, as yet unpublished, is known. This describes solvent-containing laminating adhesives that crosslink via silane groups. The NCO groups of the prepolymers are reacted off via aminosilanes. The quantity is selected in such a way that no NCO groups are contained in the adhesive. The concentration of alcohols in the adhesive layer, for example from the crosslinking reaction, can be decreased by adding compounds having carboxylic acid anhydride groups.

The compositions of the existing art have a variety of disadvantages for use as a laminating adhesive. Isocyanate-containing adhesives are not unobjectionable for occupational safety reasons. In addition, storage is possible only under strictly anhydrous conditions. Silane-curing systems contain or form monovalent alcohols upon crosslinking. These can negatively influence the contents of film or foil packages. In addition, a reduction in cleavage products promotes the crosslinking reaction. Because the polymers are built up from NCO prepolymers, sufficient quantities of reactive silane compounds to ensure absence of NCO are required. That results in an elevated number of crosslinking reactive constituents. Shelf stability is greatly reduced by the quantity of silane groups. In addition, establishment of complete bonding is delayed.

The object of the present invention is therefore to make available an adhesive that has low viscosity at room temperature and can be applied in a thin layer onto large substrate areas. After crosslinking, the adhesive layer is intended to comprise as far as possible no migratable physiologically objectionable ingredients; for example, primary aromatic amines or monofunctional alcohols are to be reduced. The adhesive is intended to exhibit good adhesion to the substrates, and rapid adhesion buildup. The adhesive is further intended to exhibit a crosslinking density that results in elastic bonding properties.

The invention is achieved by making available a crosslinkable one-component laminating adhesive containing 25 to 80 wt % polyester prepolymers, polyether prepolymers, and/or polyurethane prepolymers that are free of NCO groups, that comprise at least one crosslinkable alkoxysilane group bound via NCO groups as well as additionally NCO groups reacted with compounds that contain no hydrolyzable groups, and the prepolymer possesses a molecular weight from 2000 to 30,000 g/mol, 74 to 19 wt % organic solvent having a boiling point of up to 130° C., 1 to 20 wt % polymers, oligomers, and/or monomers that contain one or more anhydride groups, as well as 0 to 15 wt % additives, where the viscosity of the adhesive is between 50 and 20,000 mPas (per DIN ISO 2555), measured at 15 to 45° C.

The prepolymers suitable according to the present invention can be manufactured by reacting polyols with an excess of diisocyanates. This yields NCO-containing intermediate products that are then reacted with bifunctional silane compounds that contain a group reactive with the polymer backbone and additionally at least one crosslinkable silane group, together with monovalent nucleophilic compounds that contain no hydrolyzable groups.

Polyester polyols suitable for the manufacture of prepolymers according to the present invention can be manufactured, for example, by polycondensation. For example, difunctional and/or trifunctional low-molecular-weight alcohols can be condensed with an excess of dicarboxylic acids and/or tricarboxylic acids. Instead of free polycarboxylic acids, the corresponding polycarboxylic acid anhydrides or corresponding polycarboxylic acid esters with alcohols preferably having 1 to 3 carbon atoms can also be used. Suitable dicarboxylic acids are, for example, succinic acid, adipic acid, suberic acid, azelaic acid, sebacic acid, and higher homologs thereof having up to 16 carbon atoms, also unsaturated dicarboxylic acids such as maleic acid or fumaric acid, dimer fatty acid or trimer fatty acid, or aromatic dicarboxylic acids, in particular the isomeric phthalic acids such as phthalic acid, isophthalic acid or terephthalic acid, anhydrides such as e.g. tetrahydrophthalic acid anhydride, hexahydrophthalic acid anhydride, glutaric acid anhydride, maleic acid anhydride, or mixtures or two or more such acids. Citric acid or trimellitic acid, for example, is suitable as a tricarboxylic acid that can optionally be added in portions. The quantities are selected so that terminal OH-functional polyester diols are obtained. In a preferred embodiment, mixtures of aliphatic and aromatic carboxylic acids are obtained.

Aliphatic alcohols are suitable in particular for reacting with the carboxylic acids recited above. Included among the suitable aliphatic alcohols are, for example, ethylene glycol, propylene glycol, butanediol-1,4, pentanediol-1,5, hexanediol-1,6, heptanediol-1,7, octanediol-1,8, and higher homologs or isomers thereof, 1,4-hydroxymethylcyclohexane, 2-methyl-1,3-propanediol, triethylene glycol, ethylene glycol, polyethylene glycol, dipropylene glycol, polypropylene glycol, dibutylene glycol, and polybutylene glycol.

Also suitable are higher-functional alcohols such as, for example, glycerol, trimethylolpropane, pentaerythritol, neopentyl glycol, and oligomeric ethers of the aforesaid substances with themselves or mixed with two or more of the aforesaid ethers with one another.

Suitable polyols for manufacturing the polyesters are also reaction products of low-molecular-weight polyfunctional alcohols with alkylene oxides, so-called polyethers. The alkylene oxides preferably have 2 to 4 carbon atoms. The reaction products of ethylene glycol, propylene glycol, the isomeric butanediols, hexanediols, or 4,4′-dihydroxydiphenylpropane with ethylene oxide, propylene oxide, or butylene oxide, or mixtures of two or more thereof, are, for example, suitable. Also suitable are the reaction products of polyfunctional alcohols such as glycerol, trimethylolethane or trimethyolpropane, pentaerythritol, or sugar alcohols, or mixtures of two or more thereof, with the aforesaid alkylene oxides to yield polyester polyols. These are to have a molecular weight from approximately 400 to approximately 2000 g/mol.

Polyester polyols that are produced from the reaction of low-molecular-weight alcohols, in particular of ethylene glycol, diethylene glycol, neopentyl glycol, hexanediol, butanediol, propylene glycol, glycerol, or trimethylolpropane with lactones, in particular caprolactone, are likewise suitable. 1,4-Hydroxymethylcyclohexane, 2-methyl-1,3-propanediol, 1,2,4-butanetriol, triethylene glycol, tetraethylene glycol, polyethylene glycol, dipropylene glycol, polypropylene glycol, dibutylene glycol, and polybutylene glycol are also suitable as alcohols.

Polyester polyols of oleochemical origin can, however, also be used. “Oleochemical” polyols are understood as polyols based on natural oils and fats, e.g. the reaction products of epoxidized fatty substances with mono-, di-, or polyfunctional alcohols or glycerol esters of long-chain fatty acids that are at least partly substituted with hydroxyl groups. Such polyester polyols can be manufactured, for example, by complete ring opening of epoxidized triglycerides of an at least partly olefinically unsaturated fatty acid-containing fat mixture using one or more alcohols having 1 to 12 carbon atoms, and subsequent partial transesterification of the triglyceride derivatives to yield alkyl ester polyols having 1 to 12 carbon atoms in the alkyl residue. Further suitable polyols are polycarbonate polyols and dimer diols (Henkel Co.), as well as castor oil and derivatives thereof.

Methods for manufacturing such OH-functional polyesters are known. Such polyester polyols are also commercially obtainable.

Another class of polyols suitable as a polymer backbone are polyether polyols. The known reaction products of diols or triols such as ethylene glycol, 1,2- or 1,3-propylene glycol, 1,4- or 1,3-butylene glycol, 1,6-hexanediol, 1,8-octanediol, neopentyl glycol, 1,4-hydroxymethylcyclohexane, 2-methyl-1,3-propanediol, glycerol, trimethylolpropane, 1,2,6-hexanetriol, with alkylene oxides such as e.g. propylene oxide, butylene oxide, are suitable as polyether polyols. These polyols can comprise two or three OH groups. Such polyols are commercially obtainable.

Polyurethane polyols are a further group of suitable polyols. They can be manufactured by reacting, in particular, diols having a molecular weight below 2000 g/mol with a deficit of diisocyanates. The alkylene diols, polyether diols, or polyester diols mentioned above can be used. The quantity of isocyanates is selected so that reaction products comprising OH groups are obtained. These polyurethane diols can be manufactured separately, but it is also possible for them to occur in portions in the reaction when the polyols are reacted with the isocyanates described below.

The molecular weight of suitable polymers is intended to be approximately from 400 to 25,000 g/mol (number-average molecular weight M_{N} as determinable by GPC), in particular from 2000 to 20,000 g/mol. At least 50% polyester polyols are preferably to be contained, in particular exclusively polyester polyols, particularly preferably polyester diols having terminal OH groups.

NCO-group-containing prepolymers can be manufactured from the above-described polyester polyols and/or polyether polyols by reaction with an excess of diisocyanates. In this context, the polyols in liquid or melted form, optionally also containing solvent, are reacted with diisocyanates. This can also be assisted by elevated temperature; it is likewise known that small quantities of catalysts can be added. By way of the selection of the isocyanates and the quantity, it is possible to ensure that only small proportions of free, unreacted diisocyanates are present in the reaction mixture. It is also optionally possible to separate out excess monomeric isocyanates by distillation. Such methods are known to one skilled in the art. The polyester can contain only terminal NCO groups, or polyurethane prepolymers having reactive NCO groups form as a result of molecular weight buildup. These polyurethane prepolymers are also suitable for synthesis of the silane-containing prepolymers to be used according to the present invention.

The known aliphatic or aromatic diisocyanates are suitable in particular as isocyanates, such as 1,6-hexamethylene diisocyanate (HDI), 1-isocyanato-3,3,5-trimethyl-5-isocyanatomethylcyclohexane (IPDI), xylylene diisocyanate (XDI), tetramethylxylylene diisocyanate (TMXDI), 2,4- or 2,6-toluoylene diisocyanate (TDI), 2,4′-diphenylmethane diisocyanate, 2,2′-diphenylmethane diisocyanate, or 4,4-diphenylmethane diisocyanate (MDI), as well as isomer mixtures thereof, cyclohexyl diisocyanate (CHDI), hexahydroxylylene diisocyanate (HXDI), m-xylylene diisocyanate (XDI), naphthalene diisocyanate (NDI), or bistoluoylene diisocyanate (TODD. The quantity is selected so that an NCO-terminated prepolymer is obtained.

According to the present invention, the NCO-group-containing reaction products are to contain on average two to three NCO groups.

In order to manufacture the prepolymers suitable according to the present invention, these NCO-group-containing reaction products are then reacted with silane compounds (A) that, in addition to a nucleophilic group, contain hydrolyzable silane groups.

Organofunctional silanes such as hydroxyfunctional, mercaptofunctional, or aminofunctional silanes of the general formula

Nu-(alkyl-Si(R²)ₐ(OR¹)_{b})_{c},

where

### Nu=NH, NH₂, SH, OH,

alkyl=C₁, C₂, C₃, C₄, C₆, linear or branched or cycloalkyl,
R²=methyl, ethyl, propyl, butyl,
a=0, 1,
R¹=alkyl residue having 1 to 20 carbon atoms, or hydrogen
b=2, 3,
c=1, 2.
are used as suitable silanes. The silane groups are intended to contain at least one, preferably two, in particular three hydrolyzable residues. C₁ to C₆ alcohols or OH groups are particularly suitable. These residues can be contained either exclusively or in mixed fashion on the silicon atom. In addition, 0 or 1 alkyl groups can be contained on the silicon atom, in particular methyl, ethyl, propyl, or butyl groups. Tri- or dialkoxysilanes having methoxy, ethoxy, propoxy, or butoxy groups are particularly suitable.

Examples of mercaptofunctional silanes are 3-mercaptopropyltrimethoxysilane, 3-mercaptopropyltrimethoxysilane or the corresponding alkyldimethoxy or alkyldiethoxy compounds. Examples of aminofunctional silanes are 3-aminopropyltrimethoxysilane (AMMO), 3-aminopropyltriethoxysilane (AMEO), 3-aminopropylmethyldimethoxysilane, 3-aminopropylmethyldiethoxysilane, N-(2-aminoethyl)-3-aminopropyltrimethoxysilane (DAMO), N-(2-aminoethyl)-3-aminopropyltriethoxysilane, N-(2-aminoethyl)-3-aminopropylmethyldimethoxysilane, N-(2-aminoethyl)-3-aminopropylmethyldiethoxysilane, N,N-di(2-aminoethyl)-3-aminopropyltrimethoxysilane, N,N-di(2-aminoethyl)-3-aminopropyltriethoxysilane, N,N-di(2-aminoethyl)-3-aminopropylmethyldimethoxysilane, N,N-di(2-aminoethyl)-3-aminopropylmethyldiethoxysilane, N-(2-aminoethyl)-N′-(2-aminoethyl)-3-aminopropyltrimethoxysilane, N-(2-aminoethyl)-N′-(2-aminoethyl)-3-aminopropyltriethoxysilane, N-(2-amino-ethyl)-N′-(2-aminoethyl)-3-aminopropylmethyldimethoxysilane, N-(2-aminoethyl)-N′-(2-aminoethyl)-3-aminopropylmethyldiethoxysilane, bis(triethoxysilylpropyl)amine, bis(trimethoxysilylpropyl)amine, N-(2-aminobutyl)-3-aminopropyltriethoxysilane, N-(2-aminobutyl)-3-aminopropyltrimethoxysilane, N-(n-butyl)-3-aminopropyltrimethoxysilane, N-(n-butyl)-3-aminopropyltriethoxysilane, N-(n-butyl)-3-aminopropylalkoxydiethoxysilane, 3-hydroxypropyltrimethoxysilane, 3-hydroxypropylriethoxysilane, 4-hydroxybutyltrimethoxysilane, or mixtures thereof, as well as corresponding compounds that carry a different alkyl group instead of the respective propyl group. A preferred embodiment uses aminosilanes, in particular α-functionalized silanes, particularly preferably α-aminosilanes, for reaction with the isocyanate prepolymers. Mixtures of several silanes can also be used.

The quantity of silane compounds (A) to be reacted is selected so that only a portion of the isocyanate groups of the prepolymer have reacted with a nucleophilic group of the silane compound. For example, on average one to two NCO groups are reacted with silane compounds. The further NCO groups still contained are simultaneously or subsequently reacted by reaction with compounds (B) that comprise only one nucleophilic group and no silane group. The quantity of these additional compounds is selected so that all NCO groups are reacted, i.e. the prepolymer obtained is free of NCO groups.

Compounds B are monofunctional compounds that comprise an OH, NH-alkyl, or SH group. It is thereby possible to ensure that no further molecular weight increase occurs. These compounds can optionally comprise further functional groups that do not react with the NCO groups under the reaction conditions. Examples thereof are ester groups, carbonyl groups, epoxy groups, olefin groups, or cyclic carbonate groups.

The molecular weight of these compounds is to be less than 500 g/mol, in particular less than 300 g/mol. Compounds having an OH group or a secondary amino group are particularly suitable. An embodiment uses monovalent alcohols, for example linear or branched C₁ to C₁₂ alcohols; another embodiment uses alcohols that additionally comprise a further functional group.

Prepolymers suitable according to the present invention must comprise crosslinkable silane groups. The number of hydrolyzable silane groups per molecule is to be equal to at least one to two. In a particular embodiment, the silane groups are terminal with respect to the polymer chain. In particular, compounds (A) that comprise crosslinkable alkoxysilane groups, as well as compounds (B) that contain no hydrolyzable groups, are to be used together in equimolar quantities with respect to the NCO groups that are present.

The reaction products suitable according to the present invention are prepolymers that contain silane groups. In a preferred embodiment, these prepolymers comprise on average two or more urethane groups, preferably two to four. The glass transition temperature of the reaction products in solvent-free form is to be between −40 and 0° C., in particular between −35° C. and −10° C. (measured using DSC). The glass transition temperature can be influenced by the quantity of aromatic components of the polymer backbone or isocyanate. It has been found that silane-reactive prepolymers that have been manufactured on the basis of isocyanates having aromatic nuclei are particularly suitable. Examples thereof are TDI, NDI, 4,4′-MDI, 2,4-MDI, mXDI, or TMXDI reacted with the starting polyols.

Laminating adhesives can be formulated from the silane-functionalized prepolymers described above. It is possible for additional constituents to be contained in these lamination adhesives, for example solvents, catalysts, stabilizers, adhesion promoters, and even, in a less preferred embodiment, plasticizers, pigments, and fillers.

According to the present invention, the one-component laminating adhesive must additionally contain compounds which comprise functional groups that can react with alcohols. It is preferred in this context if the reaction between alcohol and the reactive group of the selected compound is an addition reaction. Preferably no low-molecular-weight substances are to be released in the context of this reaction. Anhydrides of organic carboxylic acids are particularly suitable as functional groups. These can be monomeric carboxylic acid anhydrides, in particular ones solid at 30° C., for example such as maleic acid anhydride (MA), phthalic acid anhydride, trimesic acid anhydride, or derivatives of such compounds. Oligomers of compounds that carry more than one organic anhydride group can also be used.

A particular embodiment of the invention uses polymers having a molecular weight greater than 1000 g/mol that comprise anhydride groups. Suitable polymers are known, in particular those having MA groups. These can be incorporated into the corresponding polymers by copolymerization; it is also possible for MA to be grafted onto polymers. Examples of suitable copolymers are copolymers of MA with styrene, vinyl acetate, or (meth)acrylates. Examples of copolymers that can be grafted with MA are base polymers made of polypropylene, polystyrene, polyesters, or polybutadienes. After they are manufactured, these can be grafted with MA in a polymer-analogous reaction using known methods. The MA content in the suitable polymers can be different; it can be from 3 mol % to approx. 60 mol % anhydride groups. It is advantageous according to the present invention if higher proportions of MA are present in the polymer, in particular from 10 to 55 mol %.

A particularly preferred embodiment uses MA-styrene copolymers. These have an MA content of between 20 and 55 mol %. These are solid substances.

The quantity of polymers or oligomers is to be between 1 and 20 wt % based on the laminating adhesive, in particular between 2 and 15 wt %. The quantity can be selected so that the quantity of anhydride groups corresponds to the quantity of alkoxy groups (in stoichiometric terms) in the adhesive according to the present invention. An excess of anhydride groups can also be used. Low-molecular-weight substances that carry nucleophilic groups and may additionally be present, such as amine-containing compounds, can also react with this constituent.

Plasticizers can be contained, for example, as further additives optionally contained in the adhesive. Suitable plasticizers are, for example, medicinal white oils, naphthenic mineral oils, paraffinic hydrocarbon oils, polypropylene, polybutene, polyisoprene oligomers, hydrogenated polyisoprene and/or polybutadiene oligomers, phthalates, adipates, benzoate esters, vegetable or animal oils, and derivatives thereof. To decrease migration out of the crosslinked adhesive layer, it is advisable to use only a small proportion of plasticizers, or none. Phenols, sterically hindered phenols of high molecular weight, polyfunctional phenols, sulfur- and phosphorus-containing phenols or amines can be selected as usable stabilizers or antioxidants.

An adhesive according to the present invention can also contain pigments or fillers. The quantities are to be equal to 0 to 5 wt %. The adhesive is, however, preferably intended to be transparent. It is likewise optionally possible additionally to add silane compounds to the adhesive as adhesion promoters. The silanes listed above, or by preference organofunctional silanes such as (meth)acryloxy-functional, epoxy-functional, or nonreactively substituted silanes can be used as adhesion promoters. In a preferred embodiment, 0 to 3 wt % of such silanes are added to the adhesive. These can optionally be incorporated into the polymer network.

An adhesive suitable according to the present invention can also contain catalysts as an optionally additionally present additive. All known compounds that can catalyze hydrolytic cleavage of the hydrolyzable groups of the silane groupings, as well as subsequent condensation of the Si—OH group to yield siloxane groupings, can be used as catalysts. Examples thereof are titanates, bismuth compounds, tin carboxylates, tin oxides, chelate compounds of aluminum or zirconium, amine compounds or salts thereof with carboxylic acids, such as octylamine, cyclohexylamine, benzylamine, dibutylamine, monoethanolamine, di- or triethanolamine, triethylamine, tripropylamine, tributylamine, diethanolamine, dipropylamine, dibutylamine, diethylenetriamine, triethylenetetramine, triethylenediamine, guanidine, morpholine, N-methylmorpholine, and 1,8-diazabicyclo-(5,4,0)-undecene-7 (DBU). The catalyst or mixtures are used in a quantity from 0.01 to approximately 5 wt % based on the total weight of the preparation. 0.05 to 4 wt %, particularly preferably from 0.2 to 3 wt % catalyst is preferred. It is preferred if the adhesive contains no tin catalysts. In particular, other heavy-metal-containing catalysts can also be avoided.

According to the present invention the adhesives also contain solvents. These are the usual solvents that can evaporate at temperatures of up to 130° C., in particular having a boiling point below 100° C. The solvents can be selected from the group of the aliphatic hydrocarbons, aromatic hydrocarbons, ketones, or esters. The solvents serve to lower and adjust the viscosity. The proportion of solvents can vary within wide limits, for example from 19 to 74% based on the adhesive. It is known in this context to adjust the adhesive to high viscosity in a delivery form; it can then be diluted with further solvent to a suitable viscosity prior to application. The sum of all constituents is to equal 100%. For good shelf stability, it is useful if the solvents used according to the present invention contain only small proportions of water, or none.

The solvents of the adhesives according to the present invention can be added in the context of manufacture. With another embodiment, however, the procedure is such that only a portion of the solvents is used during manufacture in order to establish a viscosity appropriate for manufacture. In the context of the composition according to the present invention, however, a further portion of the solvents is added to the adhesive shortly before processing in order to obtain a suitable application viscosity. With this embodiment it is possible for the solvents that are not added until shortly before application of the solvent also to contain organic monofunctional alcohols at least in part. Examples thereof are C₁ to C₆ monovalent alcohols. In accordance with the requirements for the solvents, these alcohols are intended to evaporate at a temperature below 130° C. Methanol, ethanol, or propanol are particularly suitable. The quantities of alcohol based on the total solvent content are to be at maximum 50%, in particular less than 25%.

It has been found that the processing stability of the adhesive having the solvents is sufficiently long. The diluted adhesives can be processed for a period of time up to 6 hours with no substantial change in reactivity upon crosslinking. Because the solvents evaporate upon application, the mode of operation of the adhesive according to the present invention is not negatively affected.

The viscosity of the suitable laminating adhesives is to be between 50 and 20,000 mPas measured at 15 to 45° C., preferably 100 to 5000 mPas (measured per Brookfield, according to ISO 2555). The adhesive is usually diluted with solvent for application. The viscosity in that context can be from approx. 50 mPas up to 800 mPas (at 20 to 45° C.). The solids content in application form is preferably between 15 and 60%, particularly preferably 30 to 50 wt %. Because rapid further processing is necessary, the adhesives are intended to crosslink quickly and to build up good cohesion and adhesion. According to the present invention, crosslinking of the applied adhesive is possible even when there is little moisture in the substrates to be bonded.

The T_{g} of the crosslinked adhesive is to be between −15 and +30° C., in particular between −10 and +20° C. A sample of less than 0.5 g of the complete adhesive that has been heated at a heating rate of 10 K per minute from 0 to 200° C., is to be regarded as a solvent-free crosslinked state. The T_{g} of the crosslinked material can then be determined by differential scanning calorimetry (DSC).

The adhesives according to the present invention are highly shelf-stable. Premature molecular-weight buildup is prevented by the reduced quantity of crosslinking groups. It is usual to store a low-solvent form, which can have a higher viscosity. In an embodiment, it is possible to heat these reduced-solvent laminating adhesives for application, for example to 45° C., and then apply them. In another embodiment, the adhesive is diluted with solvents to a low viscosity upon utilization, and then applied. The viscosity of the adhesive remains low even upon extended storage.

A further subject of the invention is the use of the crosslinkable silane-functionalized adhesives according to the present invention to manufacture multi-layer films or foils. Also a subject of the invention is a multi-layer film or foil that is adhesively bonded using a laminating adhesive suitable according to the present invention. The known flexible films or foils can be used as film or foil materials for the manufacture of multi-layer films or foils. These are, for example, substrates made of thermoplastics in film or foil form, for example polyolefins such as polyethylene (PE) or polypropylene (PP, CPP, OPP), polyvinyl chloride (PVC), polystyrene (PS), polyesters such as PET, polyamide, organic polymers such as cellophane; metal films or foil or paper are also possible as substrates. The film or foil materials can also be modified, for example by modifying the polymers with functional groups, with metal coatings or oxide coatings; or additional components, for example pigments, dyes, or foamed layers can be contained in the film or foil. The films or foils can be colored, imprinted, colorless, or transparent.

In the context of the use according to the present invention, two or more identical or, in particular, different films or foils are adhesively bonded to one another with a one-component adhesive suitable according to the present invention. A liquid laminating adhesive according to the present invention is then applied onto the optionally pretreated film or foil. This can be done with pressure methods known per se, for example using patterned rollers, smooth rollers; the adhesive is sprayed on via nozzles; or the adhesive is applied via slit nozzles. The application method is to be selected as a function of the viscosity of the adhesive. The adhesive can be applied at a thin layer thickness from 1 to 25 μm, in particular from 2 to 15 μm. The solvents that is contained evaporate immediately thereafter, and a second film or foil is then applied onto the adhesive layer and press-joined with pressure.

The alcohols evaporate quickly in the context of the application process. Only small quantities of residual alcohols, or those from the crosslinking reaction, are captured by the oligomer/polymer having anhydride groups that is present.

It is possible for the adhesive to crosslink quickly because of the quantity of alkoxysilane groups that is selected. No bubbles—which are difficult to avoid with isocyanate-based adhesives in the context of highly reactive systems—are produced by the reaction. A further advantage of the crosslinked laminating adhesive is the outstanding shelf stability in dissolved form.

The adhesive according to the present invention exhibits good adhesion between the different layers. It is, in particular, colorless and transparent. It exhibits no bubbles or defects in the adhesive layer. It is therefore especially suitable as a laminating adhesive for bonding flexible film- or foil-shaped substrates. In addition, the alcohols that occur upon crosslinking are captured by the anhydride-group-containing polymers. This produces high-molecular-weight reaction products that are not migration-capable. Crosslinked adhesive layers that contain only small proportions of migration-capable substances are therefore obtained. Multi-layer films or foils of this kind are therefore particularly suitable for the packaging industry, for example to manufacture packages for foods or medical products.

### EXAMPLES

### Example 1

### Polyester

A polyester was produced from adipic acid and isophthalic acid together with diethylene glycol.

The polyester had a molecular weight of approx. 2000 g/mol. The OH number was approx. 58; the acid number was less than 2.

### Example 2

### Prepolymer

51.5 parts of polyester 1 were dissolved in 38.5 parts ethyl acetate and then reacted with 6 parts TDI 100. 2 parts bis(3-triethoxysilylpropyl)amine were then added, as well as 0.4 parts ethanol.

The resulting product had a solids content of 62%. It contained no further isocyanate groups. The viscosity was approx. 1500 mPas (20° C.), the molecular weight (M_{N}) approx. 8000 g/mol.

### Example 3

### Prepolymer

49 parts of polyester 1 were dissolved in 38.5 parts ethyl acetate and then reacted with 5.4 parts TDI 100. 2 parts bis(3-triethoxysilylpropyl)amine were then added, as well as 2 parts stearyl alcohol.

The resulting product had a solids content of 62%. It contained no further isocyanate groups. The viscosity was approx. 2000 mPas (20° C.), the molecular weight (M_{N}) approx. 8000 g/mol.

### Example 4

### Adhesive

1.6 parts (approx. 2.5% in terms of solids) of a styrene copolymer containing approx. 50 wt % MA blocks was added to the prepolymer of Example 2 and homogenized. The viscosity was approx. 1500 mPas (20° C.).

### Example 5

### Adhesive

1.6 parts (approx. 2.5% in terms of solids) of a styrene copolymer containing approx. 50 wt % MA blocks was added to the prepolymer of Example 3 and homogenized. The viscosity was approx. 2000 mPas (20° C.).

### 6

### Comparison;

51.5 parts of polyester 1 were dissolved in 38.5 parts ethyl acetate and then reacted with 6 parts TDI 80. 4.3 parts bis(3-triethoxysilylpropyl)amine were then added.

The resulting product had a solids content of 62%. It contained no further isocyanate groups.

1.6 parts (approx. 2.5% in terms of solids) of a styrene copolymer containing approx. 50 wt % MA blocks was added to the prepolymer and homogenized. The viscosity was approx. 1400 mPas (20° C.).

| Viscosity | 1 d | 70 d (20° C.) | 70 d (50° C.) |
|---|---|---|---|
| Adhesive 4 | 1500 | <2000 | ≈3000 mPas |
| Adhesive 5 | 2000 | <2000 | ≈5000 nnPas |
| Comparison 6 | 1400 | approx. 4500 | |

All the adhesives were diluted prior to application with ethyl acetate to a solids content of approx. 31%.

The viscosity was in each case below 800 mPas (20° C.).

### Adhesive Bonding:

Films based on polyethylene (PE) were coated with the adhesives according to the present invention using a blade. The layer thickness was 5 μm.

Another film was coated analogously, with a layer thickness of 10 μm. The coated surface was flashed off for approx. 1 min at 30° C. A second film based on OPP was then squeegeed with a roller onto the respective coated film.

PET films were coated with the adhesives, using a blade, at a layer thickness of 3 g/m². After flashing off, these films were bonded to an aluminum foil.

The adhesive bonding of the film or foil substrates was determined after 6 days and after 14 days. Good mutual adhesion was observed in all cases.

After 24 hours, the ethyl acetate content and ethanol content from the adhesively bonded films and foils was determined by headspace GC.

| Example | EtOH | EtOAc | Adhesion |
|---|---|---|---|
| 3 | <20 | 2 mg/m² | 4-5 N/15 mm |
| 4 | <20 | 2 | 4-5 N/15 mm |

The experiments show that the alcohol content was decreased by the addition of the MA-containing constituents. The adhesive having a reduced silane content exhibits a particularly low viscosity over the storage time as compared with adhesives having a higher silane content.

1. A crosslinkable one-component laminating adhesive containing
a) 25 to 80 wt % polyester prepolymers, polyether prepolymers, and/or polyurethane prepolymers that are free of NCO groups, that comprise at least one crosslinkable alkoxysilane group bound via NCO groups as well as additionally NCO groups reacted with compounds that contain no hydrolyzable groups, and the prepolymer possesses a molecular weight from 2000 to 30,000 g/mol,
b) 74 to 19 wt % organic solvents having a boiling point of up to 130° C.,
c) 1 to 20 wt % polymers, oligomers, and/or monomers that contain one or more anhydride groups,
d) 0 to 15 wt % additives,
where the viscosity of the adhesive is between 50 and 20,000 mPas (per DIN ISO 2555), measured at 15 to 45° C.

2. The one-component adhesive according to claim 1, wherein the polyester prepolymer or polyurethane prepolymer is manufactured from polyester polyols having a molecular weight from 400 to 25,000 g/mol and that comprise two OH groups to three OH groups.

3. The one-component adhesive according to claim 1, wherein the prepolymer contains on average fewer than two trialkoxysilane groups selected from triethoxysilane groups, trimethoxysilane groups and tripropoxysilane groups.

4. The one-component adhesive according to claim 1, wherein the prepolymers are manufactured by reaction of polyester polyols with an excess of diisocyanates to yield an NCO-group-containing prepolymer, where aminosilanes and monovalent OH—, NHR—, or SH-containing compounds having a molar mass below 500 g/mol are then reacted with the NCO group containing prepolymer.

5. The one-component adhesive according to claim 4, wherein the adhesive comprises 2 to 15 wt % polymers, oligomers, and/or monomers having a cyclic anhydride group.

6. The one-component adhesive according to claim 5, wherein the anhydride-containing polymers have a molecular weight greater than 1000 g/mol and are selected from MSA-styrene copolymer and MSA-(meth)acrylate copolymer.

7. The one-component adhesive according to claim 1, wherein the quantity of cyclic anhydride groups corresponds stoichimetrically at least to the quantity of alkoxy groups.

8. The one-component adhesive according to claim 4, wherein monovalent compounds containing —OH, —SH, or —NH-alkyl groups are used as compounds that contain no hydrolyzable groups.

9. The one-component adhesive according to claim 8, wherein monovalent linear or branched alcohols, having up to 12 carbon atoms are reacted as monovalent compounds.

10. The one-component adhesive according to claim 1, wherein up to 50%, based on all solvents of methanol, ethanol, propanol or combinations thereof, are contained as an organic solvent.

11. The one-component adhesive according to claim 1, wherein the compounds (a) and the compounds (b) are used together in equimolar quantities with respect to the NCO groups that are present.

12. A method for adhesively bonding film or foil substrates, comprising providing the one-component adhesive according to claim 1; adjusting adhesive viscosity before application with solvents that contain C₁ to C₆ alcohols; applying the viscosity adjusted adhesive onto a first substrate; removing solvent from the applied adhesive; and bonding to a second film or foil substrate.

13. Use of one-component adhesives according to one of claims 1 to 10 for adhesive bonding of flexible film- or foil-shaped substrates, in particular polymer films or foils, paper films or foils, metal films or foils, and surface-treated films or foils.
